(19) United States
(12) Patent Application Publication
(10) Pub. No.: US 2016/0301108 A1
(43) Pub. Date: Oct. 13, 2016

(54) RECHARGEABLE CHLORIDE BATTERY

(71) Applicant: PROCESS RESEARCH ORTECH INC., Mississauga (CA)

(72) Inventors: Ashok Bhowmick, Mississauga (CA); Ramamritham Sridhar, Oakville (CA); Vaikuntam I. Lakshmanan, Mississauga (CA)

(73) Assignee: PROCESS RESEARCH ORTECH INC., Mississauga (CA)

(21) Appl. No.: 15/092,717

(22) Filed: Apr. 7, 2016

Related U.S. Application Data
(60) Provisional application No. 62/145,086, filed on Apr. 9, 2015.

(51) Int. Cl. H01M 10/39; H01M 4/46; H01M 4/583

(52) U.S. Cl. CPC H01M 10/399; H01M 4/583; H01M 4/463; H01M 2004/028

(57) ABSTRACT

The present invention relates to storage batteries, also known as rechargeable batteries, using a chloride electrolyte, especially in which the electrolyte is a ternary chloroaluminate. In particular embodiments, the electrolyte is molten chloroaluminate and especially molten at a temperature of about 140° C. In another embodiment, the electrolyte is in a liquid state, especially at a temperature in the range of −27° C. to 110° C. The preferred electrodes are aluminum and graphite. The batteries have a variety of uses, particularly including storage of electricity for future use.

### REFERENCE TO RELATED APPLICATIONS

This application claims priority under 35 USC 119(e) from U.S. Provisional Application No. 62/145,086 filed Apr. 9, 2015.

### FIELD OF THE INVENTION

The present invention relates to storage batteries, also known as rechargeable batteries, using a chloride electrolyte, especially in which the electrolyte is a ternary chloroaluminate. In particular embodiments, the electrolyte is molten chloroaluminate and especially molten at a temperature of about 140° C. In another embodiment, the electrolyte is in a liquid state, especially at a temperature in the range of −27° C. to 110° C. and especially at −27° C. to 90° C. The preferred electrodes are aluminum and graphite. The batteries have a variety of uses, particularly including storage of electricity for future use.

### BACKGROUND TO THE INVENTION

Electricity may be generated in many ways, but to do so on an “as needed” basis can be a challenge. Some systems for power generation, for example hydro and gas generators, operate continuously or can be made to do so. In other generating systems, particularly those that may be classified as renewable energy e.g. solar and wind power, production of electricity may depend to a great extent on the immediate local climatic conditions. For these systems, a reservoir in the form of an efficient power storage as a support to micro-grids is indispensable. A reservoir of power storage permits distribution of power at those times when there is insufficient light for solar systems or there is a lack of wind to operate a wind generation system.

Power storage is of increasing importance in the modern world. Depending on the strength of the power sources, the storage could be of variable capacity from kWh to MWh. Of the many different technologies being worked out for large scale grid-storage, pumped hydro storage (PHS) is the only mature technology but this requires a very large physical footprint, for water storage, and capital intense installation. Other technologies at various stage of successive deployment include Compressed air (CAES), Sodium-sulfur (NaS) batteries, Low speed Flywheel, Molten salt (at elevated temperature), Lithium-ion batteries and Flow batteries. Many other technologies are at a demonstration stage. Nevertheless, with respect to physical footprint, installation capital, operational costs, energy efficiency and output performance, batteries are believed to be the best compromise.

Among different existing battery technologies, the promising ones that have higher stake in fabricating moderate to large storage units are (i) Lead-Acid Batteries (LAB) and (ii) Lithium ion batteries (LIB). LAB systems are believed to have a total global consumption capacity of 300 GWh/year at a cost of $150/kWh, while LIB systems have a substantially lower consumption of $270/kWh. These costs are believed to be too high for a successful grid-scale operation. The success of LAB systems is primarily because of its simple chemistry with excellent thermal management and lowest material cost. However, despite technologically improved lead recycling facilities, an estimated 40 000 metric tons of harmful toxic lead compounds end up in landfill every year; the major use of these batteries is as automotive starter batteries. This is an environmental problem that needs to be addressed. The challenge for an alternate emerging technology is that it has to be competitive in all the essential LAB attributes in addition to being environmentally friendly.

Though the LIB systems have a conceptually complicated and fundamentally different chemistry added to the high cost of Li-metal, their tremendous success is primarily because lithium can give the highest reduction potential (or per unit voltage) and energy density (or gravimetric capacity) as a solid state battery. Research trials are underway on large scale modules for grid storage and electric vehicle applications. Challenges include poor global reserve of lithium, and poor thermal management because of inherent volatility of the chemistry. Enormous amounts of small application usage could lead to cumulative increase in the cost of the metal.

There are a number of emerging technologies. Examples are sodium-sulphur and sodium-nickel chloride batteries, which operate at above 300° C. Sodium has the moderate potential (−2.71 V), and sodium ion batteries (SIB) are gaining popularity. Advantages include large abundance and lower cost of sodium.

Another recent approach is the Aqueous Intercalation Battery (AIB), which is a Na/Li polyion battery using NaTi₂(PO₄)₃ with activated carbon as the anode, cubic spinel LiMn₂O₄ with activated carbon as the cathode and an aqueous solution of Na₂SO₄+Li₂SO₄ as the electrolyte. The system has robust recyclability but smaller capacity. Even though the electrolyte salt solution is easier and cheaper, the synthesis of the electrode materials is chemically quite involved and requires mechanical forming to obtain particular shapes and sizes. The electrolyte freezes below −5° C.

Theoretical studies predict the energy densities of various metal/metal chloride systems to be higher than that of the LIB systems. A major challenge to a suitable battery lies in the development of an electrolyte with high chloride ion conductivity. Recent research has been conducted on CoCl₃/Li, VCl₃/Li, BiCl₃/Li, BiCl₃/Mg. systems using the mixture of commercially available ionic liquids [(OMIM)Cl] i.e. 1-methyl-3-octylimidazolium chloride and [(BMIM)BF₄] i.e. 1-butyl-3-methylimidazolium tetrafluoroborate as the electrolyte, the cathodes being formed using carbon black as a packing material. A BiCl₃ system has shown good stability and low volume change during cycling. However, use of Bi has concerns of cost and toxicity.

Electricity has typically been generated using a variety of sources. Many traditional electrical generating stations use coal or natural gas, or geothermal energy or are hydro electrical generating stations. All of these methods of generating electricity can provide a continuous supply of electricity. In some cases electricity is easily generated “on demand”. However, the use of natural gas and especially coal leads to generation of by-products e.g. carbon dioxide and other pollutants that are hazardous to the environment.

Other methods of generating electricity e.g. wind and solar power, are environmentally friendly and generate few or no hazardous by-products during generation of electricity. However, these systems suffer from serious and unpredictable problems. In particular, solar systems require sunlight and cannot generate electricity at night or when it is cloudy or raining. Wind power requires sufficient wind strength to turn wind turbines and there are many hours or days when there is insufficient wind. Thus, generation of electricity with these systems can be very sporadic. An effective electrical storage system is required to enable society to take advantage of the environmental benefits of wind and solar power, and other sporadic electrical generating systems e.g. tidal energy, and deliver electricity as required by society. Many operations in the modern world cannot operate without a reliable continuous supply of electricity.

### SUMMARY OF THE INVENTION

The present invention relates to storage batteries, also known as rechargeable batteries, using a ternary chloroaluminate electrolyte and a combination of electrodes that are able to function in such an electrolyte .

Accordingly, in one aspect, the present invention provides a storage battery comprising:
(a) a cathode;
(b) an anode; and
(c) a molten electrolyte, said molten electrolyte being a chloroaluminate having a eutectic melting point of less than 150° C.

In a preferred embodiment, the molten electrolyte is formed from a mixture comprising sodium chloride, potassium chloride and aluminum chloride. In particular, the molten electrolyte is a ternary chloroaluminate formed from a mixture of aluminum chloride, sodium chloride and potassium chloride, especially a ternary chloroaluminate formed from a mixture of aluminum chloride, sodium chloride and potassium chloride in a ratio of 2:1:1.

In another embodiment, the molten electrolyte has a eutectic melting point of less than 135° C.

In a further embodiment, the cathode is aluminum and the anode is graphite. In particular, the anode is reduced graphite oxide (RGO).

The present invention further provides an electrolyte for a storage battery, said electrolyte being formed from a crystallized eutectic salt of sodium chloride, potassium chloride and aluminum chloride, said electrolyte being a liquid at a temperature in the range of −27° C. to 110° C.

In a preferred embodiment of the electrolyte, the electrolyte is formed from ternary chloroaluminate. In particular, the electrolyte is formed by admixing the eutectic salt with a solution of sodium hydroxide to form a slurry followed by admixing the slurry with a solution of hydrogen peroxide to form a liquid electrolyte, said electrolyte being a liquid at a temperature in the range of −27° C. to 90° C.

The present invention further provides a storage battery comprising:
(a) a cathode;
(b) an anode; and
(c) a liquid electrolyte, said electrolyte being formed from a ternary chloroaluminate obtained from a mixture comprising sodium chloride, potassium chloride and aluminum chloride, said electrolyte being a liquid at a temperature in the range of −27° C. to 110° C.

In a preferred embodiment of the storage battery with liquid electrolyte, the electrolyte is formed by admixing the ternary chloroaluminate with a solution of sodium hydroxide to form a slurry followed by admixing diluted slurry with a solution of hydrogen peroxide to form a liquid electrolyte, said electrolyte being a liquid at a temperature in the range of −27° C. to 90° C.

In a further embodiment, the liquid electrolyte is formed from a eutectic salt of sodium chloride, potassium chloride and aluminum chloride, said electrolyte being a liquid at a temperature in the range of −27° C. to 110° C. In particular, the eutectic salt is ternary chloroaluminate, and especially a ternary chloroaluminate formed from a mixture of aluminum chloride, sodium chloride and potassium chloride in a ratio of 2:1:1.

In another embodiment, the cathode is aluminum and the anode is graphite, especially in which the graphite is exfoliated graphite.

In a further embodiment, the anode is a cylindrical tube, the cathode is stacked circular plates and extends through the inside of the anode in a spaced apart relationship, the space between the anode and cathode being filled with fibrous aluminum silicate. In particular, the anode is a seamless cylindrical tube.

### BRIEF DESCRIPTION OF THE DRAWINGS

The present invention is illustrated by the drawings in which:

FIG. 1 is a schematic representation of the melting point of a ternary chloroaluminate;

FIG. 2 is a schematic representation of powder XRD data of a ternary chloroaluminate;

FIG. 3 is a schematic representation of XRD and SEM scans of a synthesized RGO sample;

FIG. 4 is a schematic representation of discharge and cycling performance of a unit cell with molten electrolyte and a single pair of electrodes;

FIG. 5 is a schematic representation of comparative loss of overall capacity of cell described in FIG. 4;

FIG. 6 is a schematic representation of test results of thermal robustness of the liquid electrolyte;

FIG. 7 is a schematic representation of the achievable capacity and cycling performance of two unit cells in series, each with liquid electrolyte and a single pair of electrodes;

FIG. 8 shows a photograph of a construction of nine pairs of electrodes and a schematic representation of discharge capacity of the cell with liquid electrolyte and with multiple pairs of electrodes

FIG. 9 shows a photograph of an experimental battery pack;

FIG. 10 is a schematic representation of performance tests of a battery; and

FIGS. 11(a-c) are schematic representations of performance tests of a battery.

### DESCRIPTION OF THE INVENTION

There are two primary aspects to the present invention of storage batteries, also known as rechargeable batteries; one storage battery using a molten chloride electrolyte and the other using a liquid chloride electrolyte. In both instances the chloride electrolyte is a ternary chloroaluminate, or derived therefrom, as described herein. The batteries have electrodes that are compatible with the conditions of use. The invention will be described with respect to each of the electrolytes, especially the use of the molten chloride electrolyte and the liquid electrolyte.

The vital components of a battery system are the electrolyte and the pair of electrodes. The chemical or the physico-chemical process within the battery determines the capacity of the battery. Batteries have two physical states viz. charged and discharged. The ‘Charged’ condition defines a situation in which energy has been pumped into the battery system from an external power source that has driven the internal chemical reaction into a forward direction where it should energetically reside, ideally, until energy is drained out by an external load. ‘Discharged’ state is the opposite, where the battery system is drained of its power under load to an exhausted state. Thus, a description of a battery system includes a description of its chemical components, conditions of operation and the chemical processes occurring during operation, as well as the anodes and cathodes of the battery. The electrolyte of the battery of the present invention is a chloroaluminate.

The present invention will now be described with respect to the aspect using a molten electrolyte. The battery system is operated with molten chloroaluminate, selected with a low eutectic melting temperature and operated near, but above, the eutectic temperature.

The potential of chloroaluminate for high energy density battery has been under investigation. The melts of these materials are understood to exhibit strong negative deviation from ideality at equimolar compositions due to short range ordering. The binary liquid phase exhibits a region of liquid-liquid immiscibility. AlCl₄⁻ tetrahedra are the fundamental structural units in the melts of binary chloroaluminates. In addition, there is substantial presence of the duplex Al₂Cl₇ units which increases in concentration with the increased concentration of AlCl₃. The equilibrium reactions are believed to be

2AlCl₃ [symbol] Al₂Cl₆; (AlCl₄)⁻+AlCl₃ [symbol] (Al₂Cl₇)⁻; 2(AlCl₄)⁻ [symbol] (Al₂Cl₇)⁻+Cl⁻

The high free chlorine ion concentration in the melt is believed to make them good candidates as electrolytes for application in chloride ion batteries (CM).

Binary systems tend to melt at substantially higher temperatures compared to ternary chloroaluminates. The melting point of ternary chloroaluminates may vary with composition, thereby giving an opportunity to obtain eutectics with lower melting points. It is believed that the equilibrium chemical reactions do not change for different compositions. One aspect of the present invention utilizes ternary chloroaluminates in chloride ion batteries. The choice of electrodes is another aspect of the batteries.

The following is an example of ternary chloroaluminates, and the electrodes, in chloride ion batteries.

### EXAMPLE I

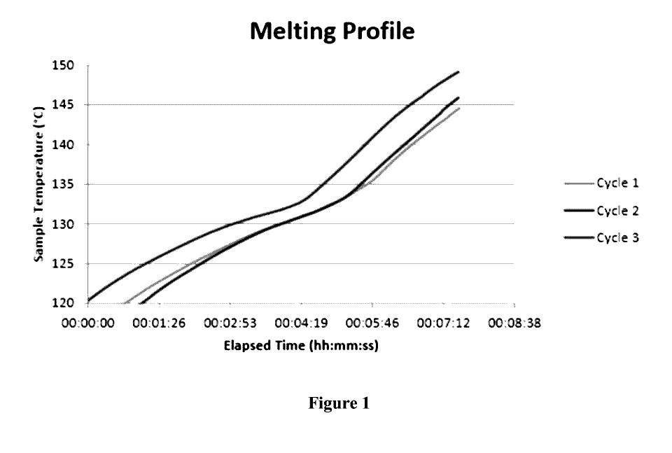

A sample of a ternary chloroaluminate was prepared by mixing commercially available high purity AlCl₃, NaCl and KCl salts obtained from Sigma Aldrich, Canada, at a 2:1:1 molar ratio within an argon-filled glove box. The sample was treated under argon (5.0 Grade) flow at 150° C., at lsccm flow rate, for 4 hours to remove traces of water or any other volatile residues. The resultant sample was then heated adiabatically in the argon-sealed container having in-situ thermal probe. This ternary chloroaluminate has an unique eutectic melting point as low as 133° C., as shown in FIG. 1, which shows the temperature of the sample measured in-situ under adiabatic condition at a sampling rate of 100 millisecond. The deviation in sample temperature due to latent heat is recorded indicating a melting transition that was also noted on visual observation of the physical condition of the sample within the glass container.

Tests showed that a eutectic 1:1 mix of NaCl and KCl had a melting point of above 650° C. A eutectic of 2:1 AlCl₃ and NaCl had a eutectic melting point of about 300° C. As the component AlCl₃ has the lowest melting point in the mixture, it is believed that to achieve lowest eutectic melting point of a ternary mixture, the proportion of AlCl₃ in the mix should be equal to the total proportion of NaCl and KCl. The eutectic melting temperature of the 2:1:1 AlCl₃, NaCl and KCl composition was the only one of the compositions tested that had a melting point below 140° C.

The procedure was repeated through several melting and freezing cycles on each specimen sample, as well as being carried out on different lots of prepared samples for consistency in the results. In order to exploit the electrolytic property of the ternary chloroaluminate melt, the operating temperature of the battery has to be above the eutectic melting point to ensure good quality ionic transport. The cell was operated under inert atmospheric condition. Thus, the electrochemical measurements were conducted at 140° C. in an argon-sealed environment maintained at 0.5 atmospheric pressure to prevent an increase in pressure due to chlorine evaporation.

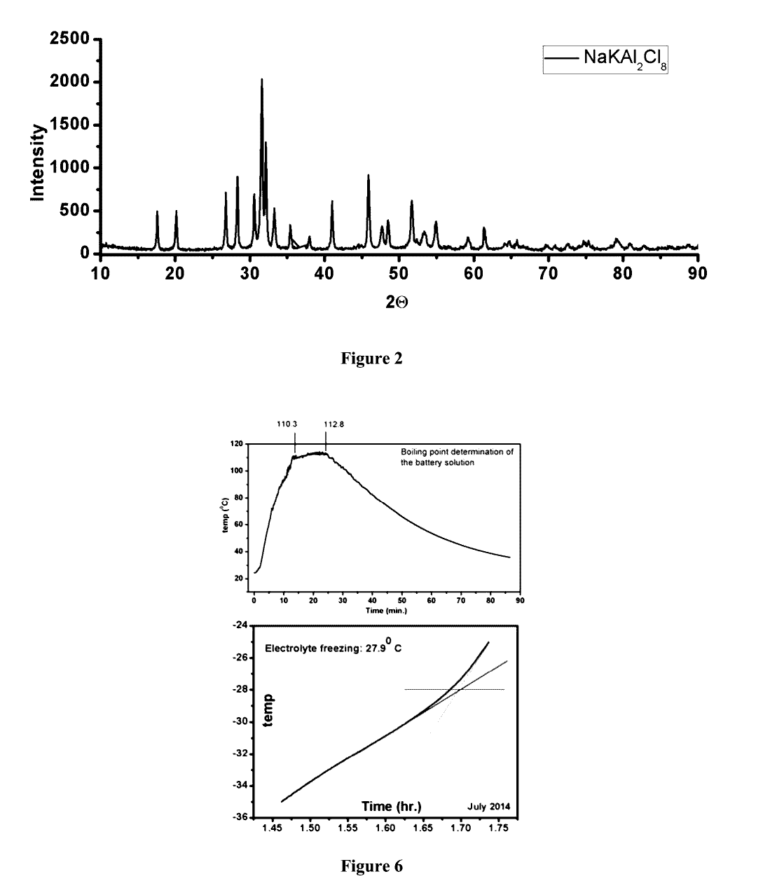

The pale-brown color eutectic melt was cooled through slow natural cooling to room temperature under inert (Ar) atmosphere to produce light lemon-yellow color ionic solid of NaKAl₂Cl₈. Ribbon-like patches typical of an ionic solid were clearly visible in the solid sample. The sample was rock hard and, once formed, can be stored and treated under natural atmosphere for use as and when required. The powder XRD data (FIG. 2) of this sample differs significantly from that of the parent compounds and reveals the formation of single phase compound. The solid sample can be re-melted under inert atmosphere to function as the battery electrolyte in molten state, as described below, and for convenience referred to as Electrolyte-I (E-I).

E-I functions as electrolyte only at an elevated temperature that is higher than the melting temperature. The tested solid E-I was found to be insoluble in water and to not dissolve in a variety of polar and non-polar solvents.

### EXAMPLE II

Test measurements of the high-temperature cell have been done using electrolyte E-I held at 140° C. to ensure that it is at molten state. The cell was fabricated out of a 2-inch diameter seamless aluminum tube having ¼ inch wall-thickness; the aluminum tube is the cathode (negative electrode). Reduced graphite oxide (RGO) was used as the anode. The anode material was packed within very fine pore cellulose paper and inserted within a tubular perforated graphite construct. The anode block was attached to a ¹/8 inch titanium rod that passes through a vacuum seal on the top cover of the cell for electrical connection; the top cover of the cell was sealed to the container using a PTFE gasket and means were provided to enable removal of air and refilling with inert gas (Ar). The cell was filled to ¾ of its volume with powdered E-I sample and kept sealed at 0.5 Torr Ar-atmosphere. A safety release valve was provided to maintain pressure at no more than 2 atmospheres. The construct of the cell allowed for heating on a hot-plate or with a heating mantle wherein the temperature can be controlled within ±5° C. using a PID controller. It was noted that once the cell attained 140° C., the pressure did not fluctuate appreciably during the operation of the cell through several hours.

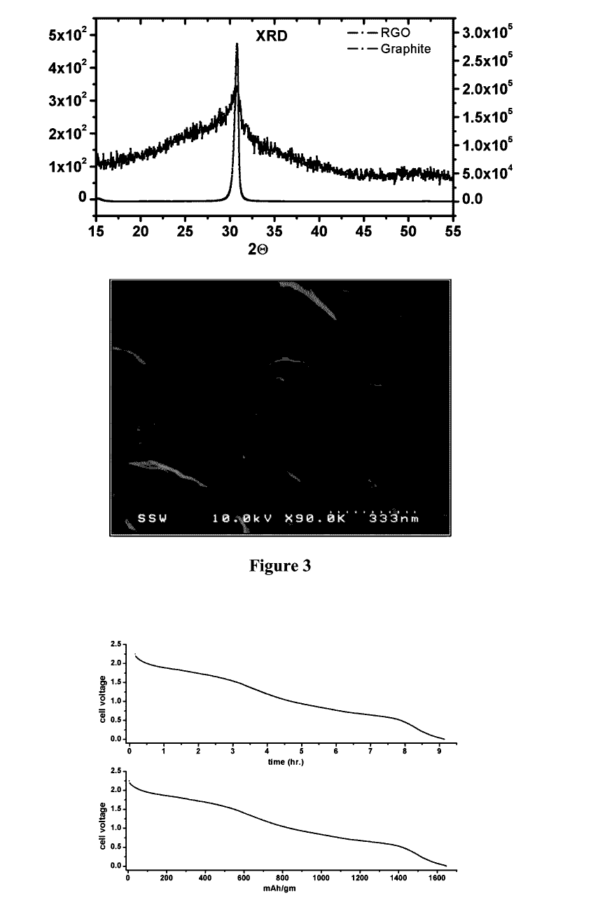

The cathode aluminum is the feeding material of the battery cell and the weight of the container is monitored for gravimetric estimation. Reduced graphite oxide (RGO), the anode material, was synthesized chemically from commercially available (Sigma-Aldrich) high purity synthetic graphite following modified Hummer's method (William S. Hummers Jr and Richard E. Offeman, J. Amer. Chem. Soc. Vol. 80, 1958, p 1339). The synthesized RGO sample is characterized by XRD and SEM studies as shown in FIG. 3. An emulsion of RGO was made in acetone mixed with 5% high quality polymer adhesive (that can sustain through 200° C.) using an ultrasonic probe. The well-mixed emulsion was put on the cellulose paper by microfiltration and vacuum dried. RGO is a the agglomeration of crumpled up graphitic sheets and is believed capable of holding a large amount of free Cl⁻ ions to enable charge transfer.

Charging of the cell commenced as soon the electrolyte E-1 attained a molten state and exhibited the base voltage 1.3 volts. The charging was first done using a constant current (CC) mode to the maximum attainable voltage and then followed through the constant voltage (CV) mode at a fixed current, which depends on the physical size of the electrodes vis-à-vis the cell itself. A maximum of 2.3 volts could be achieved per cell. Cyclic voltammetry and CC discharge measurements were performed with the charged cell to estimate the stability on continuous recycling over a period of time and the capacity rating. All measurements are performed using a professional MACCOR battery tester MC-4 from Maccor Inc. USA.

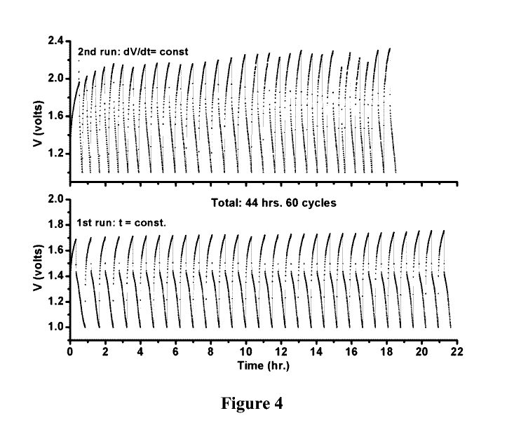

FIG. 4 shows the discharge and cycling performance for one such unit cell at single electrode configuration. A total discharge@15 mA continued over 9 hrs resulting in a capacity of 1600 mAh/gm; 50% discharge takes about 6 hrs. Two results for 60 cycles running the cell continuously for 44 hrs are shown. The first 30 cycles were done keeping the change in voltage per unit time (dV/dt) at a constant value and the next 30 cycles were done by charging the cell for a constant time of 30 minutes followed by discharge. The cell was maintained at 140° C. for operation throughout the duration of the tests. The results show the robustness of the cell over various modes of repetitive power drive.

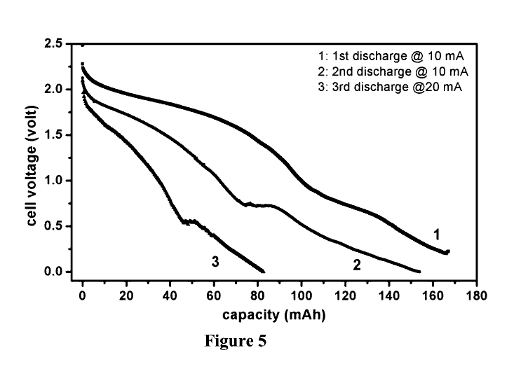

FIG. 5 shows the comparative loss in overall capacity of the test-cell over successive discharges at different rates after charging the cell partially for only 30 minutes. The premier discharge runs for 16 hrs.

As this is a high temperature cell, it is to be expected that there will be an associated evaporation loss that depends on a number of design factors. For larger versions, implementation of external self-discharge compensation circuits e.g. a capacitor bank, may be needed.

In use, once a complete run of the cell is over and it is brought down to ambient temperature, the cell may require servicing in terms of fresh material inputs. Nonetheless, pack-specific parameters e.g. energy (watt) and current rating (CA), have to be determined on particular designed modules in the prototyping of this technology. This type of device would find application as large stationary backup to power grids.

The present invention will now be described with respect to the aspect in which the electrolyte is a liquid chloroaluminate. The electrolyte E-1 and formation thereof has been described above.

E-I functions as electrolyte only at an elevated temperature that is higher than the melting temperature. Thus, in one aspect, use in storage batteries is restricted to temperatures above the melting point with the upper limit being determined by practical considerations. The tested solid E-I was found to be insoluble in water and to not dissolve in a variety of polar and non-polar solvents. The batteries of the second aspect of the invention are intended to operate over a wide range of temperatures, especially temperatures associated with everyday living. The electrolyte is in a liquid form i.e. with the electrolyte not in a molten form. The following is an example of preparation of the electrolyte for this aspect.

### EXAMPLE III

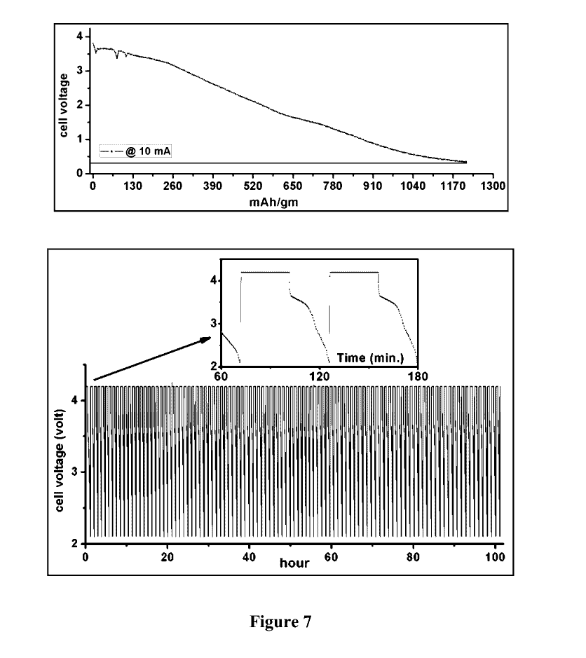

Solid E-I was treated with dilute NaOH solution and stirred to initially obtain a dense white mix, referred to as a slurry. The slurry was then diluted with deionized water and 30% H₂O₂ was added, to obtain a clear pale yellow solution that had the characteristic odour of oxychloride. This solution is referred as E-II and was used as the electrolyte of a battery cell functioning at room temperature. The density of the solution was 1.25 gm/cc and the pH was tuned to be approximately between 1.7-2.0 for the use as battery electrolyte. It was tested for its thermal robustness through a range of temperature that determined the freezing and boiling point as −27.9° C. and +110° C. respectively (FIG. 6). This electrolyte is referred to as E-II.

The measured potential (−1.3 to −1.4) and acidic pH of the solution indicates that at equilibrium the reduction of Cl⁻ and Cl₂ is as follows:

Cl⁻+3H₂O [symbol] 6H⁺+(ClO₃)⁻+6e⁻; 1/2Cl₂+3H₂O [symbol] 6H⁺+(ClO₃)⁻+5e→(−1.47 V)

Cl⁻+4H₂O [symbol] 8H⁺+(ClO₄)⁻+8e⁻; 1/2Cl₂+3H₂O [symbol] 6H⁺+(ClO₃)⁻+7e→(−1.34 V)

The conversion to chlorate and perchlorate is also reflected in the thermal stability of the solution through a very wide range of temperature; it is possible that small amounts of hypochlorite and chlorite are present. No precipitate was observed after the final conversion, suggesting that the melt-synthesized eutectic salt E-I did not decompose to create individual metal chlorates in solution. The dynamic conversion of the acid at equilibrium as, 4HClO₂→2ClO₂+(ClO₃)⁻+Cl⁻+2H⁺+H₂O; 6HClO₃→4ClO₃+(ClO₄)⁻+Cl⁻+2H⁺+2H₂O, is believed to sustain the electrochemical drive.

Using electrolyte E-II, test measurements of the room temperature cell were performed on 2-unit cells in series, yielding a total voltage double that of each one. The maximum voltage per unit cell obtained was 1.9 volt yielding 3.8 volt in total for the test unit. Tests were done with single electrode pair per unit cell without any additional separator material other than the spacing in between the electrodes. Commercial exfoliated graphite sheets were used as the anode; this material is formed from synthetic exfoliated graphite powder under high pressure and cannot be machined precisely. Therefore, the anode plate was attached on holders made out of graphite rods.

Slow charging was carried out first in CC mode up to the maximum voltage limit and then at CV mode at that voltage till the change in current over unit time (dI/dt) drops down to zero. The total time of charging depends on the rate and the material content. It was found that a maximum of 133% overcharging voltage could be applied to tune the time for complete charging, but this is expected to vary with the number of electrode pairs in a specific battery module. FIG. 7 shows the typical achievable capacity more than 1200 mAh/gm. It also shows the charge-discharge cycling data for more than 100 hours of continuous operation where the charging is done through 30 minutes in each cycle and discharge is done to 50% of the maximum voltage. Two successive cycles are shown expanded at the inset. The data indicates high stability in rechargeable cycles and projects the possibility of achieving higher current efficiency using multiple pairs of electrodes.

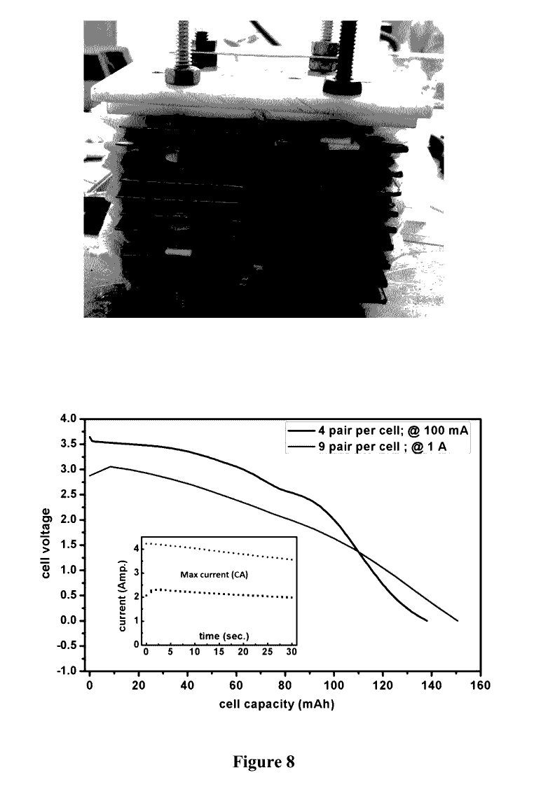

Using the same cell caging, both 4 and 9 electrode pairs were tested. Cotton fiber net was used as the separator material. The volume of the caging permits a maximum of 9 pair of electrodes in this configuration in the unit tested. The minimum separation between opposite electrodes in any pair was maintained to about 5 mm. FIG. 8 shows the photograph of a typical construct with 9-pairs of electrodes and the discharge capacities for both with 4-pairs and 9-pairs, with results shown as well in FIG. 8. It shows that even though the total capacity of the test cell does not alter, the maximum discharge current improves by several orders of magnitude. A maximum of 100 mA could be drawn out of the 4 pair cell whereas the 9-pair cell could give a discharge current as high as 1 Amp. Thereby, under this configuration, the power of the test cell is about 2.4 Watt. The cranking Amp (CA) was measured at over 1 ohm external load as shown at the inset. In the 9-pair, a maximum of 4 Amp could be drawn over the recommended time for standardization.

With an improved separator material, a higher number of electrode pairs could be piled to improve the power of the test cell. This indicates that a battery pack having desired capacity and power could very well be designed and built on the basis of these studies.

As described above, the liquid electrolyte was formed from solid ternary chloroaluminate by forming a slurry with sodium hydroxide solution, and then treating the slurry with hydrogen peroxide until a clear solution was obtained. Sodium hydroxide was used because the ternary chloroaluminate contains sodium. Similarly, potassium hydroxide could be used. Other hydroxides could be used, but result in introduction of addition of different cations. A range of concentrations of hydrogen peroxide could be used e.g. solutions of 10-30% hydrogen peroxide. Hydrogen peroxide is compatible with other components in the electrolyte. The amount of hydrogen peroxide is determined by the amount needed to get a clear solution. Excess dilution of the liquid electrolyte will result in decreased electrical potential.

### EXAMPLE IV

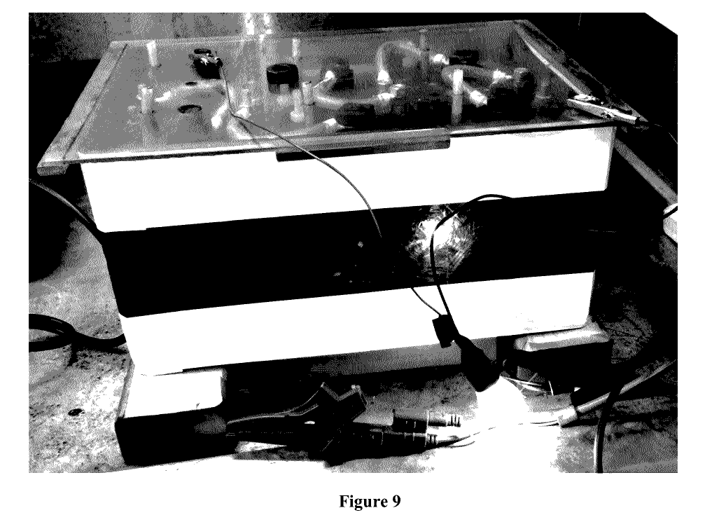

A 5.4 volt battery pack was built to further illustrate the invention. FIG. 9 shows a photograph of this battery pack. Unlike the parallel plate electrode arrangement as shown in FIG. 8, the individual cells in this embodiment have cylindrical anodes and stacked circular plates as the cathodes, wherein the cathodes are positioned inside the anodes along the vertical axis of the cylinder. Each anode is approximately 100 mm in length and 74 mm in diameter with a wall thickness of 7 mm. Each cathode plate is 44 mm in diameter with 3 mm thickness. Each cathode stack has 45 discs in it that run over the whole length of the anode cylinder. By this arrangement of the embodiment, the total surface area of the cathode is approximately twice that of the anode. Aluminum silicate fiber (commercially known as Fiberfrax) is used as the separator material between the anode and the cathode in the construction, instead of cotton that had been used in the cell described in FIG. 8. This material is insulating, does not react with the electrode materials and can hold the electrolyte similar to cotton. Further, it can provide the requisite rigidity in the construct. The entire electrode arrangement was housed in a home-built PVC casing having six chambers (square cross section) to hold six individual cells at a time. After the cells were filled with the liquid electrolyte, electrical Interconnects were done externally through a single PVC lid placed on top covering all the cells. Two individual cells are connected in parallel to double the capacity and then three such “double” cells were connected in series to give a step up in the voltage to a maximum of 5.4 volt. This is shown symbolically as (II---).

In an alternate embodiment, three individual cells were put in parallel and then two such “triple” cells were connected in series, shown as (III--).

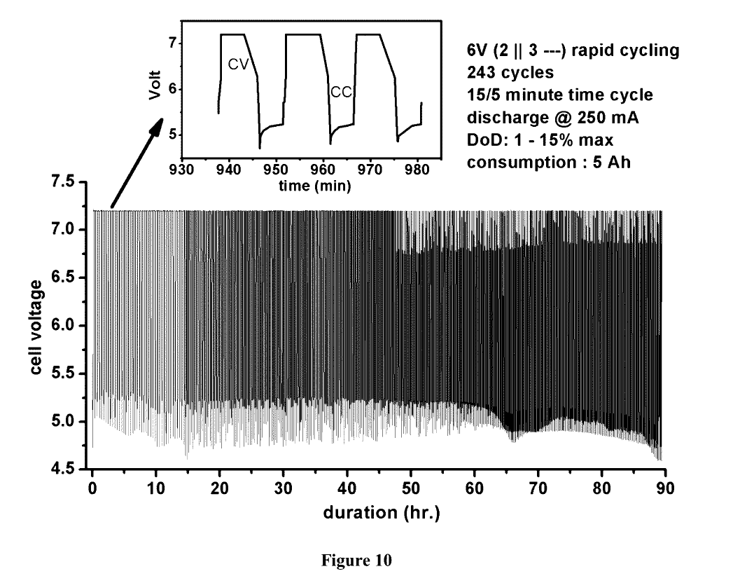

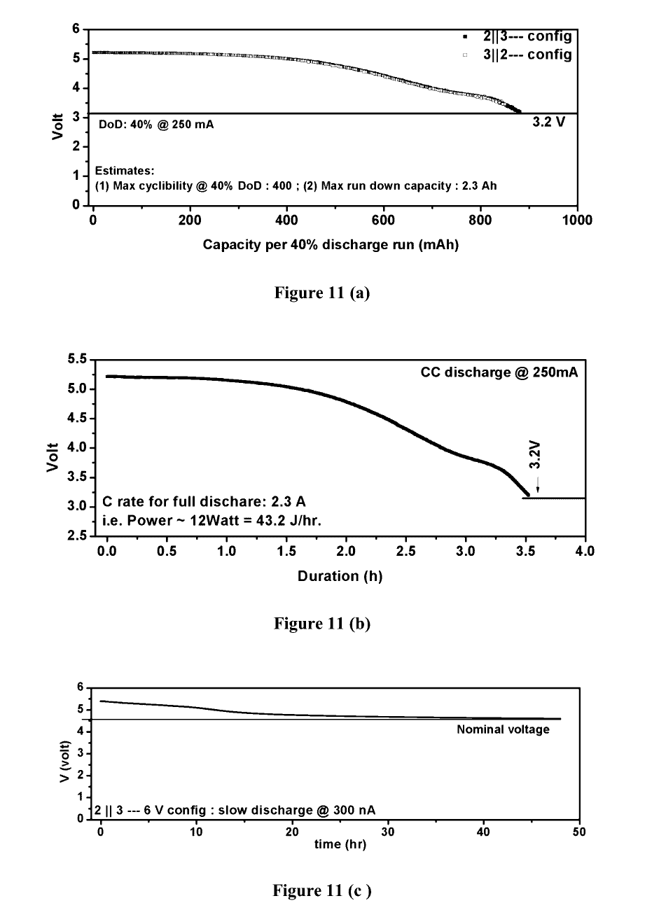

Several performance tests of the “double” cell battery pack were carried out, as shown in FIGS. 10 and 11(a,b,c), illustrating the potential of this functional battery system.

FIG. 9 shows the embodiment of the 5.4 Volt battery pack, with six cells. Two cells are in parallel and three such parallels are connected in series. The embodiment has cylindrical anodes and stacked circular discs as cathodes, positioned along the axis of the anode. FIG. 10 depicts the CV charging and CC discharging cycles of the battery pack shown in FIG. 9, performed continuously for 90 hours. The inset of FIG. 10 shows single time limited cycle with current rating. FIG. 11 presents the discharge capacity of the battery pack shown in FIG. 9. The rate of discharge is the same as shown in FIG. 10. In FIG. 11(a), the depth of discharge (DoD) is 40% at both two-in-parallel/three-in-series (referred to in the Figure as 2//3) and three-in-parallel/two-in-series (referred to in the Figure as 3//2) combinations of the 6 individual cells in the battery pack. This discharge condition could be maintained up to 400 cycles. FIG. 11(b) depicts the power and C-rate as estimated out of the discharge data. FIG. 11(c) presents a slow discharge data as an estimate of stability. It is to be understood that the battery packs shown are for illustration of the invention.

The preferred cathode is aluminum, especially because the electrolyte contains aluminum chloride. However, other cathode materials compatible with the conditions of use, including temperature, could be used. The preferred anode material is graphite, which is inert under the conditions of use, although other anodes compatible with conditions of use may be used. The form of the graphite will depend on the conditions of use. For example, reduced graphite oxide (RGO) is a preferred anode for use with molten electrolyte. Exfoliated graphite is preferred for use with liquid electrolyte.

The storage batteries with molten electrolyte are intended to be used in stationary installations, because of the high temperature of operation and the need for feedback from its own output to sustain continuous operation.

The storage batteries with liquid electrolyte described herein may be used in fixed locations but also have the potential for use in portable end-uses. The latter could include automotive batteries, household use or in commercial establishments. Such uses would typically be at ambient temperatures. The batteries of the invention offer a number of advantages over existing batteries. For instance, the batteries would have a weight of about ⅓ of that of LAB batteries because of the materials used. The materials used are not toxic. The electrolyte can be recycled for reuse and metals recovered, and ultimately the electrolyte can be washed away with water. There is no or minimal environmental pollution from the batteries or their manufacture, and the batteries may be operated through a wide range of temperature e.g. −27° to +90° C.

What we claim is:

1. A storage battery comprising:
(a) a cathode;
(b) an anode; and
(c) a molten electrolyte, said molten electrolyte being a chloroaluminate having a eutectic melting point of less than 150° C.

2. The storage battery of claim 1 in which the molten electrolyte is formed from a mixture comprising sodium chloride, potassium chloride and aluminum chloride.

3. The storage battery of claim 2 in which the molten electrolyte has a eutectic melting point of less than 135° C.

4. The storage battery of claim 1 in which the cathode is aluminum and the anode is graphite.

5. The storage battery of claim 4 in which the molten electrolyte is a ternary chloroaluminate formed from a mixture of aluminum chloride, sodium chloride and potassium chloride.

6. The storage battery of claim 5 in which the molten electrolyte is a ternary chloroaluminate formed from a mixture of aluminum chloride, sodium chloride and potassium chloride in a ratio of 2:1:1.

7. The storage battery of claim 5 in which the anode is reduced graphite oxide (RGO).

8. An electrolyte for a storage battery, said electrolyte being formed from a crystallized eutectic salt of sodium chloride, potassium chloride and aluminum chloride, said electrolyte being a liquid at a temperature in the range of −27° C. to 110° C.

9. The electrolyte of claim 8 in which the electrolyte is formed from ternary chloroaluminate.

10. The electrolyte of claim 9 in which the electrolyte is formed by admixing the eutectic salt with a solution of sodium hydroxide to form a slurry followed by admixing the slurry with a solution of hydrogen peroxide to form a liquid electrolyte, said electrolyte being a liquid at a temperature in the range of −27° C. to 90° C.

11. A storage battery comprising:
(a) a cathode;
(b) an anode; and
(c) a liquid electrolyte, said electrolyte being formed from a ternary chloroaluminate obtained from a mixture comprising sodium chloride, potassium chloride and aluminum chloride, said electrolyte being a liquid at a temperature in the range of −27° C. to 110° C.

12. The storage battery of claim 11 in which the electrolyte is formed by admixing the ternary chloroaluminate with a solution of sodium hydroxide to form a slurry followed by admixing diluted slurry with a solution of hydrogen peroxide to form a liquid electrolyte, said electrolyte being a liquid at a temperature in the range of −27° C. to 90° C.

13. The storage battery of claim 11 in which the liquid electrolyte is formed from a eutectic salt of sodium chloride, potassium chloride and aluminum chloride, said electrolyte being a liquid at a temperature in the range of −27° C. to 110° C.

14. The storage battery of claim 13 in which the eutectic salt is ternary chloroaluminate.

15. The storage battery of claim 14 in which the ternary chloroaluminate is formed from a mixture of aluminum chloride, sodium chloride and potassium chloride in a ratio of 2:1:1.

16. The storage battery of claim 11 in which the cathode is aluminum and the anode is graphite.

17. The storage battery of claim 16 in which the graphite is exfoliated graphite.

18. The storage battery of claim 16 in which the anode is a cylindrical tube, the cathode is stacked circular plates and extends through the inside of the anode in a spaced apart relationship, the space between the anode and cathode being filled with fibrous aluminum silicate.

19. The storage battery of claim 18 in which the anode is a seamless cylindrical tube.
